(19) United States
(12) Patent Application Publication
(10) Pub. No.: US 2026/0205405 A1
(43) Pub. Date: Jul. 16, 2026

(54) COPROCESSOR, METHOD PERFORMED THEREBY AND COMMUNICATION DEVICE

(71) Applicant: Telefonaktiebolaget LM Ericsson (publ), Stockholm (SE)

(72) Inventors: Tonghai Gao, Beijing (CN); Haitao Fu, Beijing (CN); Zhanhong Xia, Beijing (CN)

(21) Appl. No.: 19/133,177

(22) PCT Filed: Dec. 2, 2022
(86) PCT No.: PCT/CN2022/136220

§ 371 Date: May 27, 2025

(51) Int. Cl. H04L 43/50; H04L 43/106; H04L 43/16

(52) U.S. Cl. CPC H04L 43/50; H04L 43/106; H04L 43/16

(57) ABSTRACT

A coprocessor, a method performed thereby and a communication device are disclosed. According to an embodiment, the coprocessor periodically processes multiple rows of a timer table in a predetermined memory space on a row-by-row basis, to use a time period required for processing the multiple rows as a time granularity for time counting. Each of at least one row of the timer table indicates a corresponding session and has multiple parts. Each of the multiple parts indicates corresponding one of multiple timers and maintains a counting value as a function of a number of the counted time granularities. The coprocessor performs, for the at least one row, one or more predetermined actions based on the counting values for the multiple timers.

### TECHNICAL FIELD

Embodiments of the disclosure generally relate to data processing, and, more particularly, to a coprocessor, a method performed thereby and a communication device.

### BACKGROUND

This section introduces aspects that may facilitate better understanding of the present disclosure. Accordingly, the statements of this section are to be read in this light and are not to be understood as admissions about what is in the prior art or what is not in the prior art.

Monitoring the performance of a link, including the measurement of packet loss and packet delay, is an important content of operation, administration and management (OAM). For example, Y.1731 loss measurement (LM)/delay measurement (DM) and two-way active measurement protocol (TWAMP) are two common protocols for link performance monitoring. Y.1731 LM/DM is for layer 2 and TWAMP is for layer 3.

Although the two protocols are different, but their behaviors are similar for realizations. FIG. 1 illustrates a typical scenario in which the two protocols are applicable. As shown, there are two roles, i.e. a sender/source maintenance end point (MEP) 110 and a reflector/destination MEP 120. According to the function splitting, the sender/source MEP 110 sends a test message, which may carry a time stamp (used for delay measurement) and sequence No. (used for loss measurement). The reflector/destination MEP 120 sends a response message, carrying its own timestamp and sequence No. The sender/source MEP 110 receives the response message, calculates delay/loss, and sends the test result to a network controller 130.

There are four timestamps in the above process. The sender MEP (or simply referred to as the sender) 110 is responsible for sending the test message carrying the exit timestamp 1 (TS1). The reflector MEP (or simply referred to as the reflector) 120 receives the test message and records the arrival time TS2. The reflector 120 sends the rebound message (or response message) carrying TS3. Finally, the rebound message returns to the sender 110 which records the arrival time TS4. The sender 110 can calculate one-way/two-way delay by using these four timestamps, and calculate one-way/two-way loss by using the sequence No. carried by the test message/response message.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

One of the objects of the disclosure is to provide an improved solution for data processing. In particular, one of the problems to be solved by the disclosure is that there is no efficient solution for processing a plurality of sessions each requiring a plurality of timers.

According to a first aspect of the disclosure, there is provided a method performed by a coprocessor. The method may comprise periodically processing multiple rows of a timer table in a predetermined memory space on a row-by-row basis, to use a time period required for processing the multiple rows as a time granularity for time counting. Each of at least one row of the timer table may indicate a corresponding session and have multiple parts. Each of the multiple parts may indicate corresponding one of multiple timers and maintain a counting value as a function of a number of the counted time granularities. The method may further comprise performing, for the at least one row, one or more predetermined actions based on the counting values for the multiple timers.

In this way, it is possible to use a simplified structure to implement a plurality of timers for each of one or more sessions.

In an embodiment of the disclosure, the coprocessor may be contained in a communication device to cooperate with a central processing unit (CPU) of the communication device.

In an embodiment of the disclosure, the multiple timers may comprise a first timer for counting a time interval between successive test messages to be sent from the coprocessor. The test message may be used for measuring communication status between the coprocessor and another communication device. The multiple timers may further comprise a second timer for counting a sending period during which a predetermined number of test messages are to be sent from the coprocessor. The multiple timers may further comprise a third timer for counting a timeout period. A test message can be determined as being lost when a response message in response to the test message is not received within the timeout period after the sending period.

In an embodiment of the disclosure, processing a row in the at least one row of the timer table may comprise one or more of: when a first counting value for the first timer in the row does not reach a first predetermined threshold, incrementing the first counting value by one; when the first counting value for the first timer in the row reaches the first predetermined threshold, resetting the first counting value to zero, and triggering a second counting value for the second timer in the row to be incremented by one; when the second counting value for the second timer in the row reaches a second predetermined threshold, resetting the second counting value to zero, and triggering a third counting value for the third timer in the row to be processed; when the third counting value for the third timer in the row does not reach a third predetermined threshold, and not all the response messages in response to the predetermined number of test messages have been received, incrementing the third counting value by one; and when the third counting value for the third timer in the row reaches the third predetermined threshold, or all the response messages in response to the predetermined number of test messages have been received, resetting the third counting value to zero.

In an embodiment of the disclosure, performing, for a row in the at least one row, one or more predetermined actions based on the counting values for the multiple timers may comprise one or more of: when a first counting value for the first timer in the row reaches a first predetermined threshold, sending a test message to the another communication device; when a third counting value for the third timer in the row reaches a third predetermined threshold, or all the response messages in response to the predetermined number of test messages have been received, generating a test report for reporting the measured communication status between the coprocessor and the another communication device; when the third counting value for the third timer in the row reaches the third predetermined threshold, sending the test report to a CPU that cooperates with the coprocessor, and reporting an interruption to the CPU.

In an embodiment of the disclosure, the test message may be an Ethernet message having a private message format. The private message format may have one or more of following fields: a first field indicating that the Ethernet message is a test message; a second field indicating one or more sessions related to the Ethernet message; a third field indicating how many sessions are contained in the Ethernet message; and a fourth field indicating the measured communication status.

In an embodiment of the disclosure, the test report may be sent to the CPU by one of: Ethernet port; and peripheral component interconnect express (PCIe) direct memory access (DMA).

In an embodiment of the disclosure, for a row in the at least one row of the timer table, separate memory spaces may be respectively used in two successive reporting periods to store information usable for generating a test report. The reporting period may be a combination of the sending period and the timeout period. The two successive reporting periods may overlap with each other by the timeout period of preceding one of the two successive reporting periods.

In an embodiment of the disclosure, the method may further comprise receiving a configuration from a CPU that cooperates with the coprocessor. The configuration may comprise one or more of: the time interval to be counted by the first timer; the predetermined number of the test messages to be sent in the sending period; the timeout period; and a message format of a test report.

In an embodiment of the disclosure, the predetermined memory space may be provided by a random access memory (RAM) of the coprocessor. Each of the multiple rows of the timer table may be stored in corresponding one address of the RAM.

In an embodiment of the disclosure, the coprocessor may be capable of supporting one or more of: Y.1731 loss measurement/delay measurement (LM/DM); two-way active measurement protocol (TWAMP); and bidirectional forwarding detection (BFD).

In an embodiment of the disclosure, the coprocessor may be implemented as at least one of: field programmable gate array (FPGA); application specific integrated circuit (ASIC); and data processing unit (DPU).

According to a second aspect of the disclosure, there is provided a coprocessor. The coprocessor may comprise a predetermined memory space configured to store a timer table. The coprocessor may further comprise a time counting component configured to periodically process multiple rows of the timer table in the predetermined memory space on a row-by-row basis, to use a time period required for processing the multiple rows as a time granularity for time counting. Each of at least one row of the timer table may indicate a corresponding session and have multiple parts. Each of the multiple parts may indicate corresponding one of multiple timers and maintain a counting value as a function of a number of the counted time granularities. The coprocessor may further comprise an action performing component configured to perform, for the at least one row, one or more predetermined actions based on the counting values for the multiple timers.

In this way, it is possible to use a simplified structure to implement a plurality of timers for each of a plurality of sessions.

In an embodiment of the disclosure, the coprocessor may be contained in a communication device to cooperate with a CPU of the communication device.

In an embodiment of the disclosure, the multiple timers may comprise a first timer for counting a time interval between successive test messages to be sent from the coprocessor. The test message may be used for measuring communication status between the coprocessor and another communication device. The multiple timers may further comprise a second timer for counting a sending period during which a predetermined number of test messages are to be sent from the coprocessor. The multiple timers may further comprise a third timer for counting a timeout period. A test message can be determined as being lost when a response message in response to the test message is not received within the timeout period after the sending period.

In an embodiment of the disclosure, the time counting component may be configured to process a row in the at least one row of the timer table by one or more of: when a first counting value for the first timer in the row does not reach a first predetermined threshold, incrementing the first counting value by one; when the first counting value for the first timer in the row reaches the first predetermined threshold, resetting the first counting value to zero, and triggering a second counting value for the second timer in the row to be incremented by one; when the second counting value for the second timer in the row reaches a second predetermined threshold, resetting the second counting value to zero, and triggering a third counting value for the third timer in the row to be processed; when the third counting value for the third timer in the row does not reach a third predetermined threshold, and not all the response messages in response to the predetermined number of test messages have been received, incrementing the third counting value by one; and when the third counting value for the third timer in the row reaches the third predetermined threshold, or all the response messages in response to the predetermined number of test messages have been received, resetting the third counting value to zero.

In an embodiment of the disclosure, the action performing component may be configured to perform, for a row in the at least one row, one or more predetermined actions based on the counting values for the multiple timers by one or more of: when a first counting value for the first timer in the row reaches a first predetermined threshold, sending a test message to the another communication device; when a third counting value for the third timer in the row reaches a third predetermined threshold, or all the response messages in response to the predetermined number of test messages have been received, generating a test report for reporting the measured communication status between the coprocessor and the another communication device; when the third counting value for the third timer in the row reaches the third predetermined threshold, sending the test report to a CPU that cooperates with the coprocessor, and reporting an interruption to the CPU.

In an embodiment of the disclosure, the test message may be an Ethernet message having a private message format. The private message format may have one or more of following fields: a first field indicating that the Ethernet message is a test message; a second field indicating one or more sessions related to the Ethernet message; a third field indicating how many sessions are contained in the Ethernet message; and a fourth field indicating the measured communication status.

In an embodiment of the disclosure, the test report may be sent to the CPU by one of: Ethernet port; and PCIe DMA.

In an embodiment of the disclosure, for a row in the at least one row of the timer table, separate memory spaces may be respectively used in two successive reporting periods to store information usable for generating a test report. The reporting period may be a combination of the sending period and the timeout period. The two successive reporting periods may overlap with each other by the timeout period of preceding one of the two successive reporting periods.

In an embodiment of the disclosure, the coprocessor may further comprise a reception component configured to receive a configuration from a CPU that cooperates with the coprocessor. The configuration may comprise one or more of: the time interval to be counted by the first timer; the predetermined number of the test messages to be sent in the sending period; the timeout period; and a message format of a test report.

In an embodiment of the disclosure, the predetermined memory space may be provided by an RAM of the coprocessor. Each of the multiple rows of the timer table may be stored in corresponding one address of the RAM.

In an embodiment of the disclosure, the coprocessor may be capable of supporting one or more of: Y.1731 LM/DM; TWAMP; and BFD.

In an embodiment of the disclosure, the coprocessor may be implemented as at least one of: FPGA; ASIC; and DPU.

According to a third aspect of the disclosure, there is provided a communication device. The communication device may comprise a coprocessor according to the above second aspect, and a CPU configured to cooperate with the coprocessor.

### BRIEF DESCRIPTION OF THE DRAWINGS

These and other objects, features and advantages of the disclosure will become apparent from the following detailed description of illustrative embodiments thereof, which are to be read in connection with the accompanying drawings.

FIG. 1 is a diagram illustrating a typical scenario in which protocols for link performance monitoring are applicable;

FIG. 2 is a diagram illustrating a timeout period for detecting packet loss;

FIG. 3 is a diagram illustrating a problem in the existing solution;

FIG. 4 is a flowchart illustrating a method performed by a coprocessor according to an embodiment of the disclosure;

FIG. 5 is a diagram illustrating an exemplary timer table according to an embodiment of the disclosure;

FIG. 6 is a flowchart for explaining the method of FIG. 4;

FIG. 7 is a flowchart for explaining the method of FIG. 4;

FIG. 8 is a diagram illustrating reporting periods according to an embodiment of the disclosure;

FIG. 9 is a flowchart illustrating a method performed by a coprocessor according to an embodiment of the disclosure;

FIG. 10 is a diagram illustrating a coprocessor and a communication device according to an embodiment of the disclosure;

FIG. 11 is a diagram illustrating an offload chip and a sender according to an embodiment of the disclosure;

FIG. 12 is a diagram illustrating an exemplary control table for use in the offload chip of FIG. 11;

FIG. 13 is a diagram illustrating an exemplary threshold table for use in the offload chip of FIG. 11;

FIG. 14 is a flowchart illustrating an exemplary process performed by the offload chip of FIG. 11;

FIGS. 15A-15B are diagrams illustrating an exemplary process performed by the sender of FIG. 11; and

FIGS. 16A-16B are diagrams illustrating an exemplary message format for reporting test result in FIG. 11.

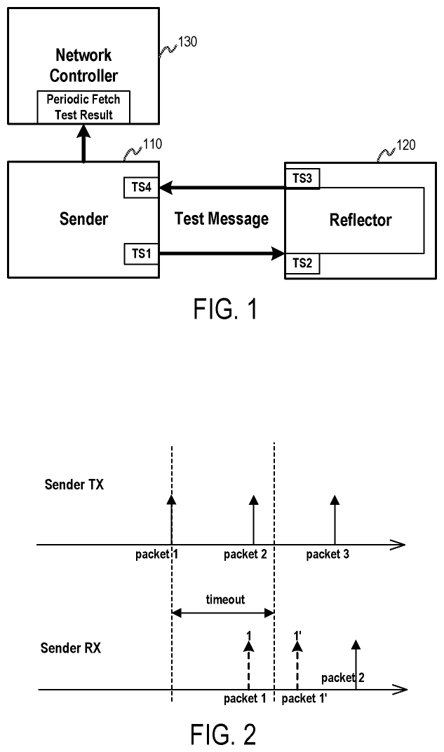

### DETAILED DESCRIPTION

For the purpose of explanation, details are set forth in the following description in order to provide a thorough understanding of the embodiments disclosed. It is apparent, however, to those skilled in the art that the embodiments may be implemented without these specific details or with an equivalent arrangement.

Timeout (or a loss threshold) is an interval of time (which may be expressed as a timestamp). A packet belonging to the test session that is being set up by the current Request-Session command will be considered lost if it is not received during Timeout seconds after it is sent. The significance of packet loss timeout is that when all messages are sent out from sender transmitter (TX), the session cannot end immediately, and the statistic of packets received by sender receiver (RX) cannot be counted immediately. It is necessary to wait for the time when the message is flying in Ethernet.

FIG. 2 illustrates the packet loss timeout. As shown, at Sender RX, Packet 1 arrives earlier than timeout threshold and should be counted, while Packet 1′arrives later than timeout threshold and should be considered discarded. If timeout is not considered in the realization, and sender RX counter is fetched immediately after the packet is sent out by sender TX, the RX count may be less in this cycle and more in the next cycle. This may introduce errors, which will cause confusion to customers. Usually, this parameter “Timeout threshold” can be configured by the customer.

In the industry, a network controller generally requires reporting test results from the whole hour, it is real time. For example, test starts at 3:00. Assuming that the presentation time interval is 15 minutes, the test results will be presented at 3:00, 3:15, 3:30, 3:45, 4:00, 4:15, . . . When the time is up, the network controller will get the test results from the CPU of the equipment.

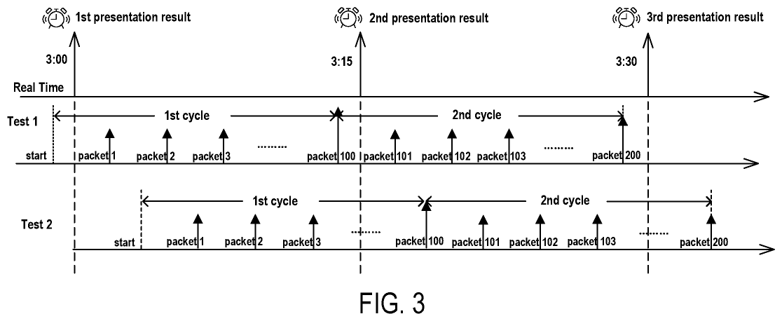

FIG. 3 illustrates the presentation of test results in the existing solution. As shown, the real presentation time of the network controller has a regular interval of 15 minutes. For the two different test sessions, Test 1 and Test 2, the end of each test cycle for Test 1 is earlier than the real presentation time, while the end of each test cycle for Test 2 is later than the real presentation time. So the end of each test cycle and the presentation time are relatively random.

There may be three types of methods for implementing link performance monitoring. The first type is pure CPU method. The advantages of this method are obvious: control layer and test layer are both realized in CPU, so the internal thread communication in CPU is very convenient; and there is no extra overhead of inter-chip communication compared with the multi-chip method.

When the requirement is getting higher and higher, for example, the sending interval of test message is getting smaller and smaller, meanwhile the session number supported is increasing, the CPU cannot meet the requirement due to its limited performance. Firstly, the architecture of CPU is not suitable for so many parallel tasks. In addition, due to thread scheduling, time accuracy may be problematic.

The second type is specific ASIC method. ASIC (such as BRCM chip from Broadcom Corporation) is customized and has good performance, but its function is rigid. It cannot be modified flexibly, and it is not friendly to customers. The test parameters and items that can be presented to customers are not rich and cannot be customized.

The third type is “CPU +offload chip (such as FPGA)” method. It is used to realize acceleration, which is a common choice. Instead of realizing the function in a single chip, two independent chips cooperate to realize the function.

How to give full play to their strengths and achieve efficient cooperation is a challenge. After all, the cooperation of the two chips will bring extra overhead. In addition, the timeout function is not realized perfectly in the existing solution, so that there are errors in the test results presented to customers.

The present disclosure proposes an improved solution for data processing. In particular, the solution is applicable to the scenario where a protocol for link performance monitoring (e.g., Y.1731 LM/DM, TWAMP, BFD, etc.) is used between two communication devices. Although the principle of the present disclosure will be described hereinafter by taking the link performance monitoring as an example, those skilled in the art will understand that the principle of the present disclosure is also applicable to any other suitable scenario where one or more sessions each requiring a plurality of timers need to be processed.

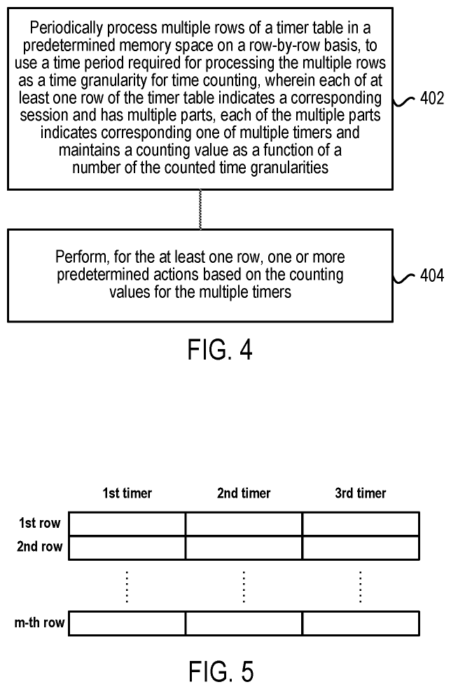

Hereinafter, the solution will be described in detail with reference to FIG. 4 to FIG. 16B. FIG. 4 is a flowchart illustrating a method performed by a coprocessor according to an embodiment of the disclosure. The coprocessor may be implemented as at least one of field programmable gate array (FPGA), application specific integrated circuit (ASIC), data processing unit (DPU), etc. As an exemplary example, the coprocessor may be contained in a communication device to cooperate with a CPU of the communication device. At block 402, the coprocessor periodically processes multiple rows of a timer table in a predetermined memory space on a row-by-row basis, to use a time period required for processing the multiple rows as a time granularity for time counting. Each of at least one row of the timer table indicates a corresponding session and has multiple parts. Each of the multiple parts indicates corresponding one of multiple timers and maintains a counting value as a function of a number of the counted time granularities. For example, the predetermined memory space may be provided by a random access memory (RAM) of the coprocessor, and each of the multiple rows of the timer table may be stored in corresponding one address of the RAM. Assume that the clock frequency of the coprocessor is k Mhz. Then, one clock cycle is 1000/ k=j ns. Assume that it takes h clock cycles to complete the processing of one row of the timer table. Then, the time granularity (i.e. the time period for processing the multiple rows) is m*h*j ns, where m is the number of the multiple rows.

The at least one row of the timer table may correspond to the session(s) for which the time counting has been enabled. In a case where the number of the at least one row is smaller than the number of the multiple rows of the timer table, the remaining row(s) of the timer table except the at least one row may correspond to the session(s) for which the time counting has not been enabled, and such session(s) may be called idle session(s). For example, for an RAM having 512 addresses, if 500 sessions are started by the customer, then 500 addresses of the RAM which correspond to 500 rows of the timer table may be used for these 500 sessions. By the processing of these 500 rows of the timer table in each time period, the counting values for the multiple timers in these 500 rows can vary as a function of the number of the time granularities. To keep the time granularity to be constant, the remaining 12 rows of the timer table also need to be processed in each time period. Since the sessions corresponding to these 12 rows are in idle state, the processing of each of these 12 rows may be simply reading the counting values in the row (which may be initialized as zero) and writing the same counting values into the row.

As an exemplary example, the session corresponding to each of the at least one row of the timer table may be a session for link performance monitoring by using e.g. Y.1731 LM/DM, TWAMP, BFD, etc. This means the coprocessor may be capable of supporting one or more of Y.1731 LM/DM, TWAMP, BFD, etc. For this example, FIG. 5 illustrates an exemplary example of the timer table. As shown, the multiple timers in each row of the timer table may comprise three timers. The first timer is used for counting a time interval between successive test messages to be sent from the coprocessor. The test message is used for measuring communication status between the coprocessor and another communication device. The second timer is used for counting a sending period during which a predetermined number of test messages are to be sent from the coprocessor. The third timer is used for counting a timeout period. A test message can be determined as being lost when a response message in response to the test message is not received within the timeout period after the sending period.

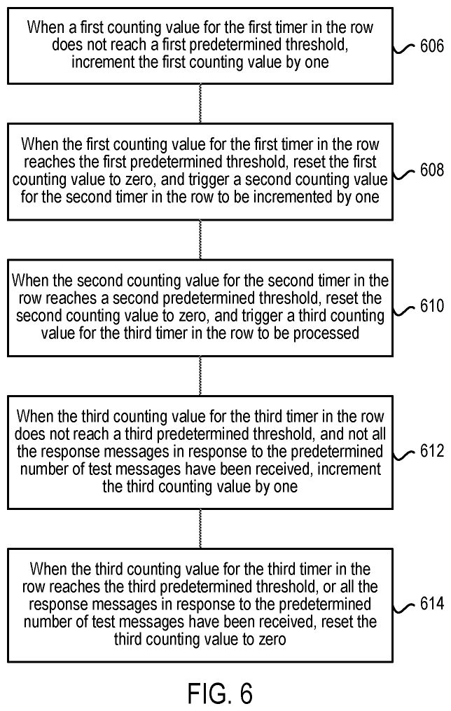

For the above example of link performance monitoring, processing a row in the at least one row of the timer table may comprise one or more of blocks 606-614 of FIG. 6. At block 606, when a first counting value for the first timer in the row does not reach a first predetermined threshold, the coprocessor increments the first counting value by one. The first counting value for the first timer may be initialized as zero. The first predetermined threshold may be determined as a quotient between the time interval between successive test messages and the time granularity. On the other hand, at block 608, when the first counting value for the first timer in the row reaches the first predetermined threshold, the coprocessor resets the first counting value to zero, and trigger a second counting value for the second timer in the row to be incremented by one. The second counting value for the second timer may be initialized as zero. Since a test message is sent from the coprocessor whenever the first counting value for the first timer reaches the first predetermined threshold, the number of the test messages which have been sent from the coprocessor can be counted by the second counting value.

At block 610, when the second counting value for the second timer in the row reaches a second predetermined threshold, the coprocessor resets the second counting value to zero, and trigger a third counting value for the third timer in the row to be processed. The second predetermined threshold may be determined as a quotient between the sending period and the time interval between successive test messages.

At block 612, when the third counting value for the third timer in the row does not reach a third predetermined threshold, and not all the response messages in response to the predetermined number of test messages have been received, the coprocessor increments the third counting value by one. The third counting value for the third timer may be initialized as zero. The third predetermined threshold may be determined as a quotient between the timeout period and the time interval between successive test messages. On the other hand, at block 614, when the third counting value for the third timer in the row reaches the third predetermined threshold, or all the response messages in response to the predetermined number of test messages have been received, the coprocessor resets the third counting value to zero.

Referring back to FIG. 4, at block 404, the coprocessor performs, for the at least one row, one or more predetermined actions based on the counting values for the multiple timers. With the method of FIG. 4, it is possible to use a simplified structure to implement a plurality of timers for each of one or more sessions.

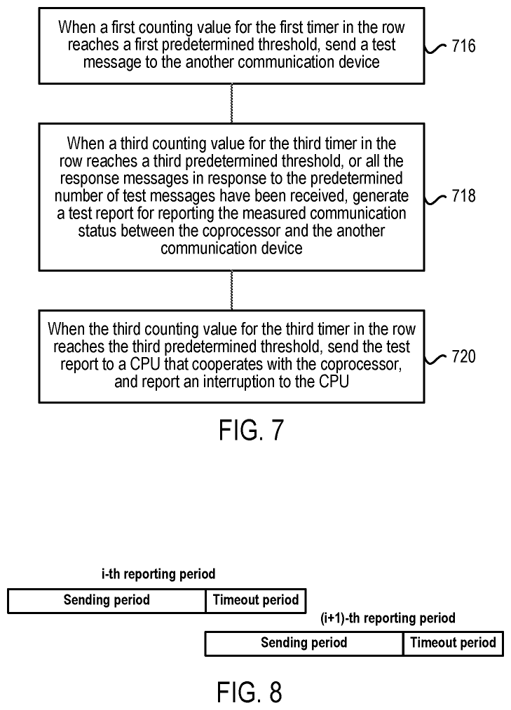

For the above example of link performance monitoring, performing, for a row in the at least one row, one or more predetermined actions based on the counting values for the multiple timers may comprise one or more of blocks 716-720 of FIG. 7. At block 716, when the first counting value for the first timer in the row reaches the first predetermined threshold, the coprocessor sends a test message to the another communication device. At block 718, when the third counting value for the third timer in the row reaches the third predetermined threshold, or all the response messages in response to the predetermined number of test messages have been received, the coprocessor generates a test report for reporting the measured communication status between the coprocessor and the another communication device.

At block 720, when the third counting value for the third timer in the row reaches the third predetermined threshold, the coprocessor sends the test report to a CPU that cooperates with the coprocessor, and reports an interruption (e.g. at the same time) to the CPU. In a case where the at least one row of the timer table corresponds to a plurality of sessions, the measured communication statuses of these plurality of sessions can be put together into the test report (e.g. in the form of one or more messages). In response to the interruption triggered by the coprocessor, the CPU can read all these measured communication statuses by using only one interaction between the CPU and the coprocessor. Compared with the traditional way of reading test result registers of the coprocessor, the number of interactions between the CPU and the coprocessor can be greatly reduced.

As an exemplary example, the test message may be an Ethernet message having a private message format. The private message format has one or more of following fields: a first field indicating that the Ethernet message is a test message; a second field indicating one or more sessions related to the Ethernet message; a third field indicating how many sessions are contained in the Ethernet message; and a fourth field indicating the measured communication status. With the private message format, the CPU can be allowed to easily identify information about session(s) and test result thereof. Optionally, the test report may be sent to the CPU by Ethernet port, or PCIe DMA, or any other suitable way.

FIG. 8 illustrates two successive reporting periods according to an embodiment of the disclosure. As shown, the reporting period is a combination of the sending period and the timeout period. The two successive reporting periods overlap with each other by the timeout period of the preceding one of the two successive reporting periods. Since the two successive reporting periods overlap with each other, the coprocessor can be configured so that for a row in the at least one row of the timer table, separate memory spaces are respectively used in the two successive reporting periods to store information usable for generating the test report. With this mechanism, storage space can be effectively saved.

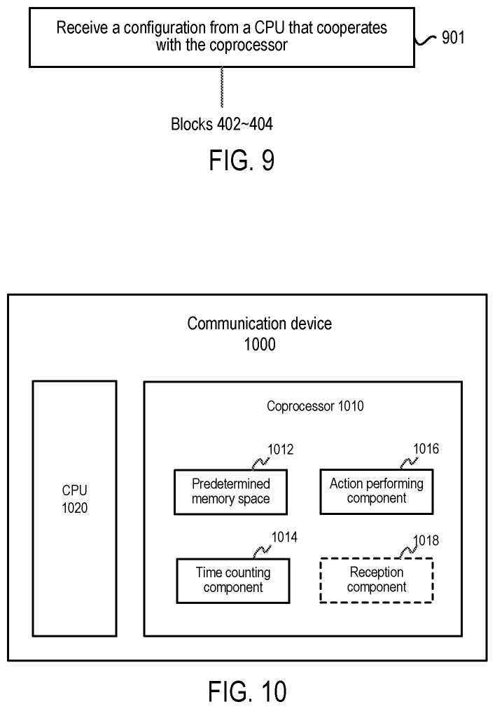

FIG. 9 is a flowchart illustrating a method performed by a coprocessor according to an embodiment of the disclosure. As shown, the method comprises block 901, and blocks 402-404 described above. At block 901, the coprocessor receives a configuration from a CPU that cooperates with the coprocessor. The configuration comprises one or more of: the time interval to be counted by the first timer; the predetermined number of the test messages to be sent in the sending period; the timeout period; a message format of a test report; etc. In this way, various parameters for link performance monitoring can be flexibly configured, which is friendly to customers. At block 402, the coprocessor periodically processes multiple rows of a timer table in a predetermined memory space on a row-by-row basis, to use a time period required for processing the multiple rows as a time granularity for time counting. Each of at least one row of the timer table indicates a corresponding session and has multiple parts. Each of the multiple parts indicates corresponding one of multiple timers and maintains a counting value as a function of a number of the counted time granularities. At block 404, the coprocessor performs, for the at least one row, one or more predetermined actions based on the counting values for the multiple timers.

FIG. 10 is a diagram illustrating a coprocessor and a communication device according to an embodiment of the disclosure. As shown, the coprocessor 1010 comprises a predetermined memory space 1012, a time counting component 1014 and an action performing component 1016. The predetermined memory space 1012 is configured to store a timer table. The time counting component 1014 is configured to periodically process multiple rows of the timer table in the predetermined memory space on a row-by-row basis, to use a time period required for processing the multiple rows as a time granularity for time counting, as described above with respect to block 402. Each of at least one row of the timer table indicates a corresponding session and has multiple parts. Each of the multiple parts indicates corresponding one of multiple timers and maintains a counting value as a function of a number of the counted time granularities. The action performing component 1016 is configured to perform, for the at least one row, one or more predetermined actions based on the counting values for the multiple timers, as described above with respect to block 404. The coprocessor may be implemented as at least one of FPGA, ASIC, DPU, etc.

Optionally, the coprocessor 1010 may further comprise a reception component 1018 configured to receive a configuration from a CPU 1020 that cooperates with the coprocessor 1010, as described above with respect to block 901. The configuration comprises one or more of: the time interval to be counted by the first timer; the predetermined number of the test messages to be sent in the sending period; the timeout period; a message format of a test report; etc. As also shown in FIG. 10, the embodiment also provides a communication device 1000 comprising the coprocessor 1010 and the CPU 1020 configured to cooperate with the coprocessor 1010.

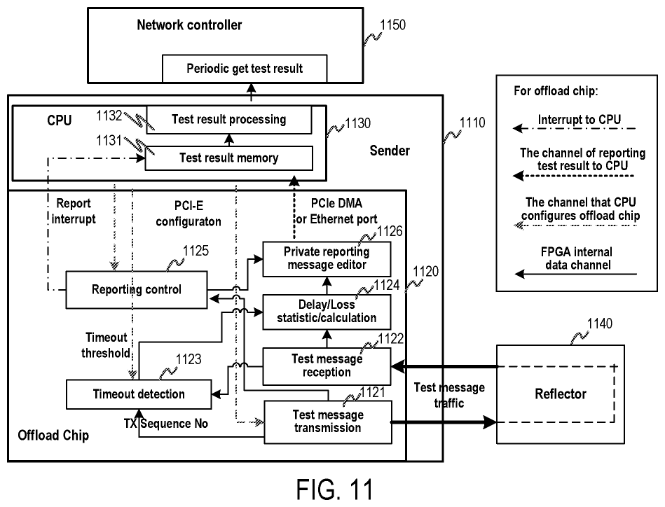

FIG. 11 is a diagram illustrating an offload chip and a sender according to an embodiment of the disclosure. In this embodiment, the coprocessor described above is implemented as an offload chip and the communication device described above is implemented as a sender. As shown, the sender 1110 is divided into two parts, a CPU 1130 and an offload chip 1120. The sender 1110 communicates test message traffic with a reflector 1140. The network controller 1150 is a network management equipment of service provider.

The CPU 1130 can issue relevant configuration to the offload chip 1120, including per session enable/disable, TX interval, message template, TX message number per presentation cycle, timeout threshold, etc.

The offload chip 1120 (e.g. the test message transmission component 1121) can periodically send test messages according to the time interval and packet template configured by the CPU 1130. The offload chip 1120 (e.g. the test message transmission component 1121) can maintain Sequence No. itself, by incrementing Sequence No. by one for each message sent. The offload chip 1120 may be a parallel architecture, which can support the parallel sending of thousands of sessions at the same time and meet the millisecond level interval.

The offload chip 1120 (e.g. the test message reception component 1122) can receive response messages and extract four Timestamp and Sequence No. The offload chip 1120 (e.g. the delay/loss statistic/calculation component 1124) can realize various statistics and calculations, which include per session delay/delay variation including two-way/far-end/near-end max/min/average, per session far-end/near-end loss, error counter, etc.

The offload chip 1120 (e.g. the private reporting message editor 1126) can lock test results and edit private reporting message when the timeout time is over or TX Sequence No. ==RX Sequence No., which can be detected by the timeout detection component 1123. The offload chip 1120 (e.g. the reporting control component 1125) can report PCIe DMA interrupt to the CPU 1130, indicating one private reporting message to the CPU 1130.

The CPU 1130 can create a thread for reading interrupt file description, once receiving an interruption. The CPU 1130 will trigger reading of DMA space and fetching of private reporting message that includes the test result. The test result can be stored in the test result memory 1131 and be further processed by the test result processing component 1132 according to an network management protocol used between the sender 1110 and the network controller 1150 so that the processed test result can be presented to the network controller 1150. It is also possible that the processing of the test result processing component 1132 is performed by the network controller 1150 so that the test result processing component 1132 is omitted from the sender 1110. Optionally, in addition to getting rough test results from the offload chip 1120, the CPU 1130 may make further statistics on the rough test results, so that the network controller 1150 can get the final test results from the CPU 1130.

In the sender 1110, the basic function of delay/loss test is realized by the offload chip 1120, and the CPU 1130 is responsible for presenting the results to customers. The functions realized by the offload chip 1120 include sending and receiving test messages, accurately calculating and counting test results, and accurately sending the test results to the CPU 1130 according to the time interval configured by customers.

To realize the above functions, the following timers need to be implemented for each session in the offload chip 1120. The first timer is used to realize the interval of sending messages. This interval may be ms level to second level. The second timer is used to realize the presentation interval configured by the customer. This interval may be at the minute level. The third timer is used to realize the timeout timer for waiting for the last message. This interval may be at the level of ms to seconds. The specification of delay/loss test may reach kilo level. There may be thousands of timers in total, which are relative and independent of each other. Therefore, how to implement a large scale of timers is a challenge, especially the time granularities of these timers are different, from ms to minutes.

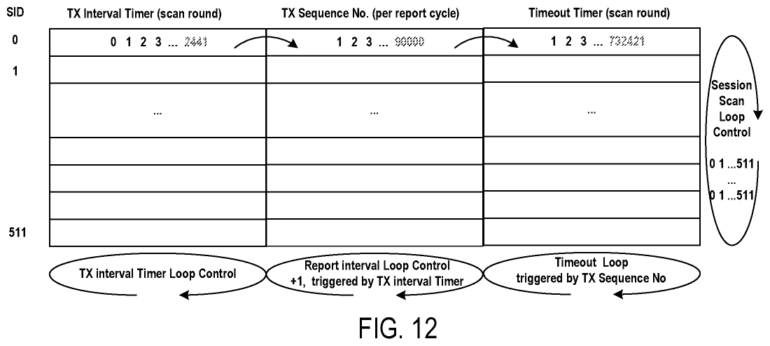

In the embodiment of FIG. 11, accurate timers for all tasks can be realized by scanning a three-in-one control table as shown in FIG. 12. That is, all timers are merged into one table. Since all timers are realized by scanning this table, the scanning time granularity should be very small, which can be compatible with all timer time granularity. This table may be implemented or instantiated with RAM resources in the offload chip, which are common resources and are not scarce. The number of supported test sessions can be easily increased as long as the offload chip has enough RAM resources. Session identifier (ID) may be used as the address of the RAM. The session ID (SID) is related to the scalability of the feature. Assuming that 512 streams are supported, then SID can take the values of 0 . . . 511.

As shown in FIG. 12, this table is two-dimensional. Each row represents a session. The number of the rows represents how many sessions there are. Each row is divided into three parts: TX interval timer, which is used to realize the message sending interval; TX sequence No. (per test cycle or per report cycle), which is used to realize the presentation interval configured by the customer; and timeout timer, which is used to wait for the last sent message. Some or all of the TX interval, customer presentation interval and packet loss timeout period may be configured by the customer.

These three parts are relative. The second one is triggered by the first one, and the third one is triggered by the second one. If these three parts are independent three tables, it is easy to cause the asynchrony of the three parts, thus leading to errors.

These three parts are also independent of each other, and they are accumulated independently. When the threshold is reached, they are reset respectively.

Every time a session is scanned, the three timers can be monitored at the same time. This ensures the strict synchronization and accuracy of the three timers.

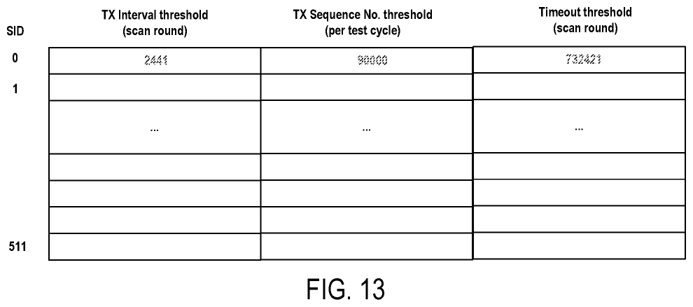

This control table can be maintained by the offload chip 1120, accumulated and compared with a threshold table as shown in FIG. 13. When the counting value in a control table counter==the configuration number in the threshold table, the next action is triggered. That is, there may be two such tables. One is the three-in-one control table controlled by the offload chip itself, which keeps scanning. The other one is the threshold table that the CPU can configure. The threshold table can be unchanged at ordinary times and will only be changed when the customer changes the configuration.

Correspondingly to the control table, the threshold table has three elements: TX interval threshold, TX sequence No. threshold per test cycle, and timeout threshold. The TX interval threshold is for per session and the time unit is scan round (corresponding to the time period required for processing the multiple rows as described above). The TX sequence No. threshold (how many packets should be sent per test cycle) is for per session. When the TX interval has been configured, the customer presentation interval can be equal to the number of packets in this presentation period. The timeout threshold is for per session and the time unit is scan round.

The TX interval threshold and timeout threshold are not the standard time, but the equivalent scanning times. Assuming that the clock frequency of the offload chip is k Mhz, then one clock cycle is 1000/k=j ns. For example, if the working clock of the offload chip is 250 Mhz, then one clock cycle is 4 ns. Using pipeline technology, it takes 2 clock cycles to complete one index's operation (or one row's operation). Assuming that the specifications (or the number of rows) supported by the offload chip are m, then the scanning time of the sender control table is m*2*j ns. For example, for an RAM having 512 addresses, it takes 512*2*4 ns=4096 ns to scan the entire sender control table from beginning to end. Then the time of scanning the entire sender control table can be taken as the time unit, instead of the real time. The granularity of the time unit is at about μs level.

Assuming that the interval of sending messages configured by the customer is p ms, then TX interval threshold=p*1000*1000/(m*2*j). For example, If the TX interval is 10 ms, then TX interval threshold is 10 ms/4096 ns=2441. This 2441 is the conversion of 10 ms into the new time unit. The calculation of the timeout threshold is similar to that of the TX interval threshold. For example, if the timeout period is 3s, then the timeout threshold is 3*10⁹/4096=732421.

In addition, assuming that the customer presentation period is q minutes, then TX sequence No. threshold=q*60*1000/p. For example, if the presentation cycle required by the customer is 15 minutes, and a message is sent per 10 ms, then there are 15*60*1000/10 ms=90000 messages in a presentation cycle.

The offload chip constantly scans the three-in-one control table and compares it with the value of the threshold table, while updating the three-in-one control table. This operation is carried out every clock cycle. In every clock cycle, the session scan control module will sequentially read the sender control table, accumulate it, and write it back.

In the above specific example, the counter of the TX interval timer sequentially takes the value of 0, 1, 2, 3, . . . , 2441. When the counter of the TX interval timer==2441, it means that the 10 ms interval is up, and session 0 starts to send out one packet. At the same time, incrementing TX sequence No. by one (TX sequence No. +1) is triggered. The offload chip resets the counter of the TX interval timer (in this example, when the TX interval timer==2441, it is reset to 0) and starts counting the new interval.

Since there are 90000 messages in a presentation cycle, the offload chip waits until TX sequence No.==90000*cycle number, meaning that the transmission of this test cycle is completed. The offload chip resets TX sequence No., and starts a new presentation cycle.

At this time, the TX sequence No. is notified to the RX timeout module, which starts the countdown of timeout. When Timeout counter==Timeout threshold, this presentation cycle is over. No matter whether the last message arrives correctly or is lost on the way, an accurate loss statistical result can be obtained at this time. The reporting of test results can be triggered.

In FIG. 12, the Session Scan Loop Control is used to control the scanning of the three-in-one control table. Starting from address 0, the control component reads out data, compares the data of two tables, accumulates or clears, and then writes back data. While reading out the three-in-one control table, the sender timer threshold table is read out at the same time, because the data of the three-in-one control table needs to be compared with the data of the sender timer threshold table to determine the next action. Pipelines can be used to reduce the cycle of the whole operation. The control component operates sequentially to the last address. Then the control component returns to the address 0. When the feature is enabled, it will always loop.

The TX interval timer loop control (scan round) is used to monitor whether the TX interval counter reaches the TX Interval threshold. When it does, it needs to trigger TX sequence No. (per report cycle)+1, and it clears itself.

The TX sequence No. loop control (per report cycle) is used to monitor whether the number of sent packets in this test cycle reaches the threshold. If so, it triggers the countdown of timeout timer, and it clears itself.

The timeout loop control (scan round) is used to monitor whether the timeout counter reaches the threshold. If it reaches the threshold, it means that the current test is completed, and the test result reporting is triggered.

Continuing with the above assumptions, a complete process is as follows. Session scan loop control starts to scan the table from address 0. When this session is scanned, if the counter of the TX interval timer is not equal to 2441, the session scan loop control adds 1 to the counter and writes it back. If it is equal to 2441, the counter of the TX interval timer is cleared, the accumulation starts again so that a new packet transmission cycle is started.

At the same time, the counter of the TX sequence No. is incremented by one (only when the counter of the TX interval timer is equal to 2441, and the TX sequence No. remains unchanged at other times). If the counter of the TX sequence No. is not equal to 90000, the TX sequence No. loop control adds 1 to the counter and writes it back.

When the counter of the TX sequence No. is equal to 90000, the TX sequence No. loop control clears it, and the counter of the timeout timer starts to accumulate. If it is not equal to 732421, the timeout loop control adds 1 to the counter and writes it back.

When this counter is equal to 732421 (732421*4096 ns=3 s), it is cleared. This presentation period is over. The timeout timer is only cycled once in a presentation period. That is, it is cycled once only when the counter of the TX sequence No. equals to 90000. The TX interval timer performs 90,000 cycles in a presentation period.

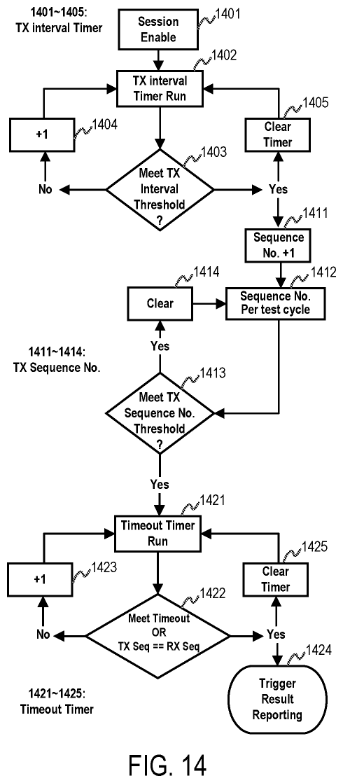

FIG. 14 illustrates an exemplary table scanning process performed by the offload chip of FIG. 11. At block 1401, whenever a row is scanned, it is checked whether the corresponding session is enabled. For example, for an RAM having 512 addresses, if 500 sessions are started by the customer, then these 500 sessions are enabled and the remaining 12 sessions are in idle state. As described above, the processing of each of these 12 rows may be simply reading the counting values in the row (which may be initialized as zero) and writing the same counting values into the row. So the subsequent blocks are described with respect to the enabled sessions. At block 1402, the TX interval timer is run. At block 1403, it is determined whether the counter of the TX interval timer meets the TX interval threshold. If the determination result at block 1403 is negative, the counter of the TX interval timer is incremented by one at block 1404. On the other hand, if the determination result at block 1403 is positive, the counter of the TX interval timer is cleared at block 1405 and the counter of the TX sequence No. is incremented by one at block 1411.

At block 1412, the sequence No. loop control is run. At block 1413, it is determined whether the counter of the TX sequence No. meets the TX sequence No. threshold. If the determination result at block 1413 is positive, the counter of the TX sequence No. is cleared at block 1414 and the timeout timer is run at block 1421. At block 1422, it is determined whether either one of the counter of the timeout timer meeting the timeout threshold, and TX sequence No. equals RX sequence No. is met. If the determination result at block 1422 is negative, the counter of the timeout timer is incremented by one at block 1423. On the other hand, if the determination result at block 1422 is positive, the counter of the timeout timer is cleared at block 1425, and result reporting is triggered at block 1424.

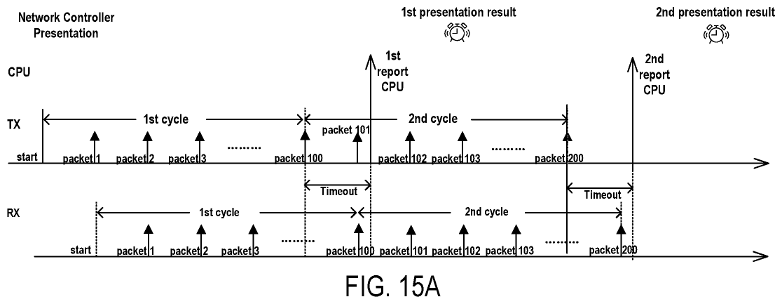

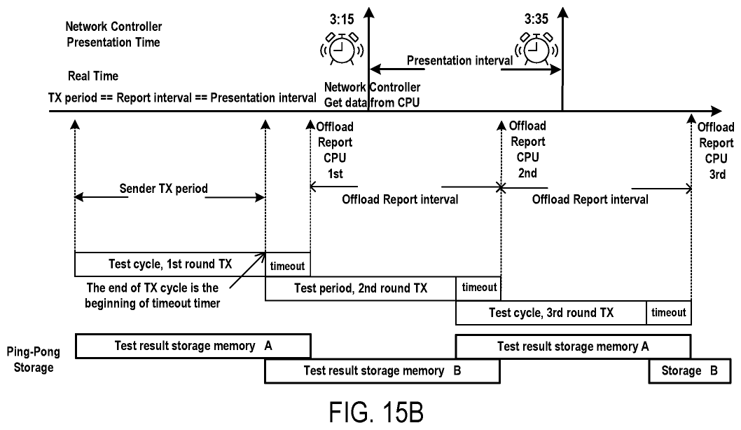

FIGS. 15A-15B illustrate the relationship between respective cycles in the embodiment of FIG. 11. As shown, the test cycle (or the TX period) in the offload chip of the sender, the report interval in the CPU of the sender, and the presentation cycle (or the presentation interval) in the network controller are equal with each other. In addition, because of the timeout, from the time dimension, in some cases, two adjacent tests may overlap so that the storage of adjacent test results also overlaps. This problem is solved by ping-pong operation. That is, separate memories A and B are used respectively for the two adjacent tests. This ping-pong operation can effectively save storage space.

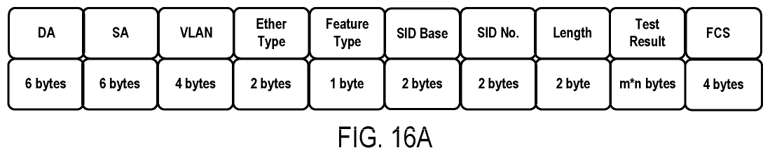

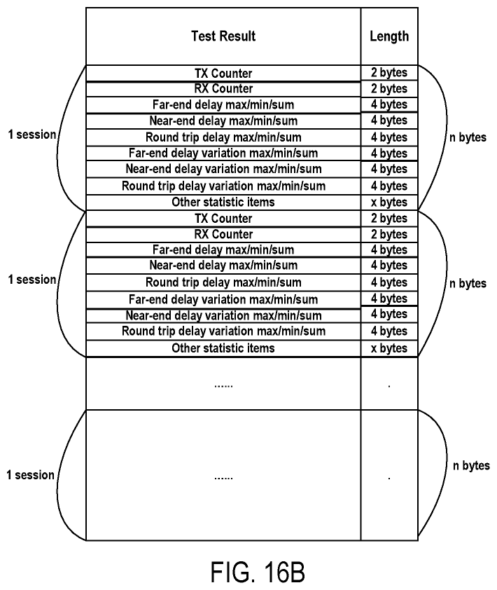

FIGS. 16A-16B illustrate an exemplary message format which may be used by the offload chip for reporting the test result to the CPU in FIG. 11. As shown in FIG. 16A, a private Ethernet message format that contains loss/delay measurement result is defined. The term “DA” refers to destination address which may be Ethernet packet destination media access control (MAC) address. The term “SA” refers to source address which may be Ethernet packet source MAC address. The term “VLAN” refers to virtual local area network and the field “VLAN” may indicate Ethernet packet VLAN type and ID. The field “Ether Type” refers to Ethernet type and may be set as “private” in this embodiment. The field “Feature Type” may be fixed to 0, indicating this is a test packet. The field “SID Base” refers to test session ID base, which is the unique ID to identify one test session. The field “SID No.” indicates how many test sessions are contained in this message. The field “Length” may cover everything after this field, in octets.

The field “Test Result” carry test raw test items. FIG. 16B illustrates an example of the test results contained in the field “Test Result”. Note that the example of FIG. 16B is merely for illustration purpose and any other test item or test item combination may be employed as needed. For example, for continuous mode, the test items may include, but not limited to: Far-end delay max/Far-end delay min/Far-end delay average, Near-end delay max/Near-end delay min/Near-end delay average, Two-way delay max/Two-way delay min/Two-way delay average, Far-end delay variation max/Far-end delay variation min/Far-end delay variation average, Near-end delay variation max/Near-end delay variation min/Near-end delay variation average, Two-way delay variation max/Two-way delay variation min/Two-way delay variation average, Far-end loss/Near-end loss/Two-way loss, Total send packet counter/Total receive packet counter, Period send packet counter/Period receive packet counter, Far-end sequence number/Near-end sequence number, etc.

For on-demand mode, the test items may include, but not limited to: Far-end delay max/Far-end delay min/Far-end delay average, Near-end delay max/Near-end delay min/Near-end delay average, Two-way delay max/Two-way delay min/Two-way delay average, Far-end delay variation max/Far-end delay variation min/Far-end delay variation average, Near-end delay variation max/Near-end delay variation min/Near-end delay variation average, Two-way delay variation max/Two-way delay variation min/Two-way delay variation average, Far-end loss/Near-end loss/Two-way loss, Total send packet counter/Total receive packet counter, Period send packet counter/Period receive packet counter, Far-end sequence number/Near-end sequence number, etc.

The offload chip can package the test results of multiple sessions or even all sessions into one private message and report it to the CPU. Compared with the way that the CPU actively get the test results of the offload chip by PCIe memory read operation, this can reduce the number of times that the CPU accesses the offload chip, and the test results of all sessions can be reported to the CPU several times or even once. Thereby, the interaction efficiency between the CPU and the offload chip can be improved and the burden of the CPU can be reduced.

Suppose there are 512 sessions, 50 test items per session, and each test item is 8 bytes. Then, total 400 bytes are required per session. The traditional PCIe memory read operation reads 4 bytes at a time. One session requires the CPU to read the offload chip 100 times. With 512 sessions, the CPU needs to visit the offload chip 51200 times. Thus, the ratio between the interactions required by the traditional method and the interactions required by the embodiment is 51200:1. This means that the number of interactions can be reduced by tens of thousands of times. Apparently, the way of packaging the test results and reporting to the CPU has great advantages.

Based on the above description, in the embodiment of FIG. 11, the offload chip plays a leading role (e.g. dominates the task such as a test function for link performance monitoring) and a CPU cooperates with the coprocessor. That is, one of the basic ideas of the present disclosure is to reduce the CPU's workload and let the offload chip take on as many tasks as possible.

For the task of link performance monitoring, when a session is enabled, the CPU only needs to set the relevant configuration to the offload chip, including e.g. the template of the message, the transmission (TX) interval of the session, the number of messages to be sent in one test cycle, and the timeout threshold. In addition, the CPU receives the test result reported by the offload chip and presents it to a network controller. The CPU is not required to start many timers, which avoids the CPU from consuming more resources.

The offload chip starts timers for each session, and the granularity of time may be at us level. The range of respective used intervals is from us to second, giving customers more choices, and this choice will not put any burden on the offload chip. With the support of the accurate timer, the offload chip can realize large-scale and accurate test message transmission. The offload chip receives the test message, realizes timeout checking and calculates the delay/loss. With the support of the accurate timer, accurate TX/RX counter and accurate reporting interval can be achieved. Thereby, accurate loss/delay statistics and test result reporting to the CPU per test cycle can be realized.

To reduce or minimize the interaction between the CPU and the offload chip, and reduce the burden on the CPU, the offload chip packages test data of several or even all sessions into a private reporting message, sends it to the CPU through Ethernet port or PCIe DMA. Note that if there is no Ethernet port between the CPU and the offload chip, PCIe is common on the printed circuit board (PCB).

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one skilled in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements. It should be noted that two blocks shown in succession in the above figures may, in fact, be executed substantially concurrently, or the blocks may sometimes be executed in the reverse order, depending upon the functionality involved.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-Limiting and exemplary embodiments of this disclosure.

1. A method performed by a coprocessor, comprising:
periodically processing multiple rows of a timer table in a predetermined memory space on a row-by-row basis, to use a time period required for processing the multiple rows as a time granularity for time counting, wherein each of at least one row of the timer table indicates a corresponding session and has multiple parts, each of the multiple parts indicates corresponding one of multiple timers and maintains a counting value as a function of a number of the counted time granularities; and
performing, for the at least one row, one or more predetermined actions based on the counting values for the multiple timers.

2. The method according to claim 1, wherein the coprocessor is contained in a communication device to cooperate with a central processing unit (CPU), of the communication device.

3. The method according to claim 1-0x 2, wherein the multiple timers comprise:
a first timer for counting a time interval between successive test messages to be sent from the coprocessor, wherein the test message is used for measuring communication status between the coprocessor and another communication device;
a second timer for counting a sending period during which a predetermined number of test messages are to be sent from the coprocessor; and
a third timer for counting a timeout period, wherein a test message can be determined as being lost when a response message in response to the test message is not received within the timeout period after the sending period.

4. The method according to claim 3, wherein processing a row in the at least one row of the timer table comprises one or more of:
when a first counting value for the first timer in the row does not reach a first predetermined threshold, incrementing the first counting value by one;
when the first counting value for the first timer in the row reaches the first predetermined threshold, resetting the first counting value to zero, and triggering a second counting value for the second timer in the row to be incremented by one;
when the second counting value for the second timer in the row reaches a second predetermined threshold, resetting the second counting value to zero, and triggering a third counting value for the third timer in the row to be processed;
when the third counting value for the third timer in the row does not reach a third predetermined threshold, and not all the response messages in response to the predetermined number of test messages have been received, incrementing the third counting value by one; and
when the third counting value for the third timer in the row reaches the third predetermined threshold, or all the response messages in response to the predetermined number of test messages have been received, resetting the third counting value to zero.

5. The method according to claim 3, wherein performing, for a row in the at least one row, one or more predetermined actions based on the counting values for the multiple timers comprises one or more of:
when a first counting value for the first timer in the row reaches a first predetermined threshold, sending a test message to the another communication device;
when a third counting value for the third timer in the row reaches a third predetermined threshold, or all the response messages in response to the predetermined number of test messages have been received, generating a test report for reporting the measured communication status between the coprocessor and the another communication device;
when the third counting value for the third timer in the row reaches the third predetermined threshold, sending the test report to a CPU that cooperates with the coprocessor, and reporting an interruption to the CPU.

6. The method according to claim 5, wherein the test message is an Ethernet message having a private message format, wherein the private message format has one or more of following fields:
a first field indicating that the Ethernet message is a test message;
a second field indicating one or more sessions related to the Ethernet message;
a third field indicating how many sessions are contained in the Ethernet message; and
a fourth field indicating the measured communication status; or
wherein the test report is sent to the CPU by one of:
Ethernet port; and
peripheral component interconnect express (PCIe) direct memory access (DMA).

7. (canceled)

8. The method according to claim 3, wherein for a row in the at least one row of the timer table, separate memory spaces are respectively used in two successive reporting periods to store information usable for generating a test report; and
wherein the reporting period is a combination of the sending period and the timeout period, and the two successive reporting periods overlap with each other by the timeout period of preceding one of the two successive reporting periods.

9. The method according to claim 3, further comprising:
receiving a configuration from a CPU that cooperates with the coprocessor, wherein the configuration comprises one or more of: the time interval to be counted by the first timer; the predetermined number of the test messages to be sent in the sending period; the timeout period; and a message format of a test report.

10. The method according to claim 1, wherein the predetermined memory space is provided by a random access memory (RAM), of the coprocessor; and
wherein each of the multiple rows of the timer table is stored in corresponding one address of the RAM.

11. The method according to claim 1, wherein the coprocessor is capable of supporting one or more of:
Y.1731 loss measurement/delay measurement (LM/DM);
two-way active measurement protocol (TWAMP); and
bidirectional forwarding detection (BFD); or
wherein the coprocessor is implemented as at least one of:
field programmable gate array (FPGA);
application specific integrated circuit (ASIC); and
data processing unit (DPU).

12. (canceled)

13. A coprocessor comprising:
a predetermined memory space configured to store a timer table;
a time counting component configured to periodically process multiple rows of the timer table in the predetermined memory space on a row-by-row basis, to use a time period required for processing the multiple rows as a time granularity for time counting, wherein each of at least one row of the timer table indicates a corresponding session and has multiple parts, each of the multiple parts indicates corresponding one of multiple timers and maintains a counting value as a function of a number of the counted time granularities; and
an action performing component configured to perform, for the at least one row, one or more predetermined actions based on the counting values for the multiple timers.

14. The coprocessor according to claim 13, wherein the coprocessor is contained in a communication device to cooperate with a central processing unit (CPU) of the communication device.

15. The coprocessor according to claim 13, wherein the multiple timers comprise:
a first timer for counting a time interval between successive test messages to be sent from the coprocessor, wherein the test message is used for measuring communication status between the coprocessor and another communication device;
a second timer for counting a sending period during which a predetermined number of test messages are to be sent from the coprocessor; and
a third timer for counting a timeout period, wherein a test message can be determined as being lost when a response message in response to the test message is not received within the timeout period after the sending period.

16. The coprocessor according to claim 15, wherein the time counting component is configured to process a row in the at least one row of the timer table by one or more of:
when a first counting value for the first timer in the row does not reach a first predetermined threshold, incrementing the first counting value by one;
when the first counting value for the first timer in the row reaches the first predetermined threshold, resetting the first counting value to zero, and triggering a second counting value for the second timer in the row to be incremented by one;
when the second counting value for the second timer in the row reaches a second predetermined threshold, resetting the second counting value to zero, and triggering a third counting value for the third timer in the row to be processed;
when the third counting value for the third timer in the row does not reach a third predetermined threshold, and not all the response messages in response to the predetermined number of test messages have been received, incrementing the third counting value by one; and
when the third counting value for the third timer in the row reaches the third predetermined threshold, or all the response messages in response to the predetermined number of test messages have been received, resetting the third counting value to zero.

17. The coprocessor according to claim 15, wherein the action performing component is configured to perform, for a row in the at least one row, one or more predetermined actions based on the counting values for the multiple timers by one or more of:
when a first counting value for the first timer in the row reaches a first predetermined threshold, sending a test message to the another communication device;
when a third counting value for the third timer in the row reaches a third predetermined threshold, or all the response messages in response to the predetermined number of test messages have been received, generating a test report for reporting the measured communication status between the coprocessor and the another communication device;
when the third counting value for the third timer in the row reaches the third predetermined threshold, sending the test report to a CPU that cooperates with the coprocessor, and reporting an interruption to the CPU.

18. The coprocessor according to claim 17, wherein the test message is an Ethernet message having a private message format, wherein the private message format has one or more of following fields:
a first field indicating that the Ethernet message is a test message;
a second field indicating one or more sessions related to the Ethernet message;
a third field indicating how many sessions are contained in the Ethernet message; and
a fourth field indicating the measured communication status; or
wherein the test report is sent to the CPU by one of:
Ethernet port; and
peripheral component interconnect express (PCIe) direct memory access (DMA).

19. (canceled)

20. The coprocessor according to claim 15, wherein for a row in the at least one row of the timer table, separate memory spaces are respectively used in two successive reporting periods to store information usable for generating a test report; and
wherein the reporting period is a combination of the sending period and the timeout period, and the two successive reporting periods overlap with each other by the timeout period of preceding one of the two successive reporting periods.

21. The coprocessor according to claim 15, further comprising:
a reception component configured to receive a configuration from a CPU that cooperates with the coprocessor wherein the configuration comprises one or more of: the time interval to be counted by the first timer; the predetermined number of the test messages to be sent in the sending period; the timeout period; and a message format of a test report.

22. The coprocessor according to claim 13, wherein the predetermined memory space is provided by a random access memory (RAM) of the coprocessor; and
wherein each of the multiple rows of the timer table is stored in corresponding one address of the RAM; or
wherein the coprocessor is capable of supporting one or more of:
Y.1731 loss measurement/delay measurement (LM/DM);
two-way active measurement protocol (TWAMP); and
bidirectional forwarding detection (BFD); or
wherein the coprocessor is implemented as at least one of:
field programmable gate array (FPGA);
application specific integrated circuit (ASIC); and
data processing unit (DPU).

23-25. (canceled)
